(19) United States
(12) Patent Application Publication
(10) Pub. No.: US 2024/0057754 A1
(43) Pub. Date: Feb. 22, 2024

(54) METHODS AND DEVICES FOR DETECTION OF SCRUBBING DURING PERSONAL HYGIENE DEVICE USE

(71) Applicant: KONINKLIJKE PHILIPS N.V., EINDHOVEN (NL)

(72) Inventors: Scott RENGEL, Bothell, WA (US); Kelly Laurence HIRSCH, Bothell, WA (US)

(21) Appl. No.: 18/271,270

(22) PCT Filed: Dec. 31, 2021
(86) PCT No.: PCT/EP2021/087910

§ 371 Date: Jul. 7, 2023

Related U.S. Application Data
(60) Provisional application No. 63/135,103, filed on Jan. 8, 2021.
(60) Provisional application No. 63/234,003, filed on Aug. 17, 2021.

(51) Int. Cl. A46B 15/00; A46B 13/02; A61C 17/22

(52) U.S. Cl. CPC A46B 15/0006; A46B 15/004; A46B 15/0044; A46B 15/0046; A46B 13/02; A61C 17/22

(57) ABSTRACT

Methods and devices for detecting scrubbing motion during use of a personal hygiene device are provided wherein false scrubbing feedback is eliminated. A method (500) may include receiving (502) motion information data of the personal hygiene device from an inertial measurement unit located within the personal hygiene device, monitoring (504) scrubbing motion data of the personal hygiene device along a first axis, monitoring (506) rotation motion data of the personal hygiene device for excessive rotation around a second axis and a third axis of the personal hygiene device, rejecting (508) a scrubbing detection when excessive rotation is detected, and providing (510) a user operating the personal hygiene device with scrubbing feedback in response to a determination that the motion information data are within predefined parameters of a targeted motion of the personal hygiene device, wherein false scrubbing feedback is eliminated from the scrubbing feedback.

### FIELD OF THE INVENTION

The present disclosure relates generally to methods and devices, such as power toothbrushes, that include sensors for sensing motion characteristics and that include user feedback capabilities.

### BACKGROUND

The effectiveness of the power toothbrush (“PTB”) can be affected by several factors related to how the user uses the toothbrush such as the user's brushing motion, brushing duration, and the force applied by the user during brushing. When brushing with a power toothbrush, most power toothbrush manufacturers recommend that users slowly move the brush head over buccal and lingual teeth surfaces to allow the vibratory motion of the brush head to properly clean the teeth surfaces and interdental areas. For example, the user instructions for a Sonicare® toothbrush (manufactured by Koninklijke Philips Electronics, N.V.) provide the following instruction: “Brush: Gently move the brush head slowly across the teeth in a small back and forth motion so the longer bristles reach between your teeth. Do not scrub like a manual toothbrush.” When a user is scrubbing, the vibratory motion of the brush head often does not dwell in one location for enough time to remove all the plaque and interdental food debris. Hence, it is desirable to obtain accurate feedback on effective brushing techniques.

### SUMMARY

There is a need for improved methods and devices that allow for accurate detection of scrubbing motion during use of a personal hygiene device.

As used herein, “scrubbing” refers to the user making a substantially sinusoidal motion along the longitudinal axis of the personal hygiene device. For a power toothbrush, a user can make a substantially sinusoidal motion along the longitudinal axis at relatively low frequencies with a stroke length of roughly 0.5 to 5 cm. A stroke length of less than about 0.5 cm is generally small enough to serve as the small back and forth motion which users are instructed to use.

In an embodiment, to promote good cleaning of teeth surfaces, brush head motion within a range of frequencies is detected and interpreted as scrubbing as follows:
When the handle is moving back and forth with a stroke length of 0.5 cm, scrubbing will be detected between a scrubbing frequency range of 3.5 Hz to 4.8 Hz with a nominal detection frequency of 4.15 Hz.
When the handle is moving back and forth with a stroke length of 5.0 cm, scrubbing will be detected between a scrubbing frequency range of 0.85 Hz to 2.15 Hz with a nominal detection frequency of 1.52 Hz.

When scrubbing detection with haptic, visual and/or audio feedback is implemented on a PTB handle, the user will be notified that they are scrubbing so they can immediately correct their brushing style. This real-time feedback leads to improved cleaning by the PTB and subsequent improved oral health.

Scrubbing detection is addressed in U.S. Patent Application Publication 2018/0160796 (“the Reference”) which is hereby incorporated by reference in its entirety. The Reference describes a detection algorithm running on a smartphone application. The algorithm uses data from a MEMS (micro-electro-mechanical system) inertial sensor chip located inside the PTB; three axes of acceleration and three axes of rate gyroscope data are streamed to the smartphone app over a Bluetooth connection.

This implementation of scrubbing detection includes a function called “gravity compensation”. The gravity compensation function is intended to solve the problem of interpreting data which are not the result of scrubbing, i.e., false scrubbing, as scrubbing by using the inertial sensors to calculate the orientation of the PTB in the Earth's gravitational field. The scrubbing detection function is aimed at detecting scrubbing actions along the longitudinal axis of the power toothbrush. During brushing, it is highly unlikely that the power toothbrush will stay at a unique orientation. As a result of this, depending on the orientation of the PTB the accelerometer channel characterizing acceleration along the longitudinal axis will contain different contributions of the gravity vector, introducing artifacts in the signal used for scrubbing detection. It was therefore desirable to remove the contribution of the gravity vector at sample level. This step is performed by using a gravity compensation mechanism which relies on:
1. Computation of the power toothbrush orientation in 3D providing a [3×3] rotation matrix—Direct Cosine Matrix (“DCM”),
2. Projection of the gravity vector [0, 0, −9.8] on the DCM matrix to determine the contribution of the gravity vector for a given orientation,
3. Subtraction of the corrected gravity component from the desired accelerometer channel.

The implementation in the Reference of the gravity compensation includes an algorithm for eliminating false scrubbing that imposes a considerable computational burden. Calculating the 3D orientation followed by use of DCM operations and subsequent matrix-based calculations is burdensome on computational resources, and limited computational resources are typically available in personal hygiene devices such as power toothbrushes. Therefore, what is needed is a scrubbing detection method with a gravity compensation function that uses less computational resources. This will enable its implementation in a PTB handle at reasonable cost.

Accordingly, it is an objective of this disclosure to provide an personal hygiene device, such as an electric toothbrush, that is capable of extracting motion characteristics of a user operating the personal hygiene device and providing feedback to the user regarding the efficacy of their technique, with an implementation that makes economical use of computing resources present within the handle of the personal hygiene device.

According to the implementations and embodiments described herein addressing such a need, a method for detecting scrubbing motion during use of a personal hygiene device, includes receiving motion information data of the personal hygiene device from an inertial measurement unit (IMU) located within the personal hygiene device, monitoring scrubbing motion data of the personal hygiene device along a first axis, monitoring rotation motion data of the personal hygiene device for excessive rotation around a second axis and a third axis of the personal hygiene device, rejecting a scrubbing motion detection when excessive rotation is detected, and providing a user operating the personal hygiene device with scrubbing feedback in response to a determination that the motion information data are within predefined parameters of a targeted motion of the personal hygiene device, wherein false scrubbing feedback is eliminated from the scrubbing feedback.

In some implementations, excessive rotation of the personal hygiene device may be determined by obtaining a rotational value from the received rotation motion data, comparing the rotational value to a set rotational threshold value, and rejecting the scrubbing motion detection when the rotational value exceeds the set rotational value. In some embodiments, the rotational value may be obtained by an averaged summed quadrature calculation. In other embodiments, the rotational value may be obtained by a summation calculation.

In some embodiments, a personal hygiene device for detecting scrubbing motion includes an inertial measurement unit and at least one processor. The inertial measurement unit measure motions of the personal hygiene device and generates motion data indicative of the motions of the personal hygiene device. The at least one processor may be operable to, during an operating session, obtain information from the inertial measurement unit corresponding to the scrubbing motion of the personal hygiene device, obtain information from the inertial measurement unit corresponding to a rotation motion of the personal hygiene device, calculate a rotational value from the received rotation motion information and compare the rotational value to a set rotational threshold value, calculate a scrubbing motion indication in parallel with the rotational value, and reject the corresponding scrubbing indication when the rotational value exceeds the set rotational threshold value. The user operating the personal hygiene device may be provided with scrubbing feedback wherein false scrubbing detection feedback is eliminated.

In some embodiments, the inertial measurement unit may include at least one accelerometer to detect the scrubbing motion of the personal hygiene device. In other embodiments, the inertial measurement unit may include at least two gyroscope sensors to determine rotation motion data of the personal hygiene device. In further embodiments, the inertial measurement unit may include a triaxial magnetometer.

In some embodiments, the personal hygiene may further include an output interface operable to provide audio, visual, and/or haptic scrubbing feedback.

In some implementations, the processor may support execution of floating-point operations. In further implementations, the processor may support execution of fixed-point operations.

In some implementations, a non-transitory computer-readable medium storing computer-executable instructions is provided that, when executed by a processor, causes an personal hygiene device to perform the disclosed method.

These and other aspects of the disclosure will be apparent from and elucidated with reference to the embodiment(s) described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the inventive subject matter.

FIG. 1A is an exploded view of a personal hygiene device including sensors in accordance with various embodiments.

FIG. 1B is an illustrative diagram of a personal hygiene device in accordance with various embodiments.

FIG. 2 illustrates the orientation of X, Y, and Z axes for a power toothbrush and its inertial measurement unit.

FIG. 3 illustrates waveform data for a Y axis accelerometer and waveform data for X axis and Z axis gyros obtained during typical scrubbing by a user.

FIG. 4 shows a flow chart depicting the determination of scrubbing in firmware with the false scrubbing rejection segments shown at the right side of the flowchart.

FIG. 5 is a high-level flow chart of a method for the determination of scrubbing in accordance with various embodiments.

### DETAILED DESCRIPTION OF EMBODIMENTS

The disclosed subject matter will become better understood through review of the following detailed description in conjunction with the figures. The detailed description and figures provide example embodiments of the invention described herein. Those skilled in the art will understand that the disclosed examples may be varied, modified, and altered without departing from the scope of the invention described herein. The present invention may take form in various components and arrangements of components, and in various techniques, methods, or procedures and arrangements of steps. The referenced drawings are only for the purpose of illustrated embodiments and are not to be construed as limiting the present invention. Various inventive features are described below that can each be used independently of one another or in combination with other features.

Aspects of the present invention are described herein with reference to flowchart illustrations and/or block diagrams of methods, devices, and computer program products according to embodiments of the invention. It will be understood that each block of the flowchart illustrations and/or block diagrams, and combinations of blocks in the flowchart illustrations and/or block diagrams can be implemented by computer-readable program instructions.

The computer-readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of methods, devices, and computer program products according to various embodiments of the present invention. Each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

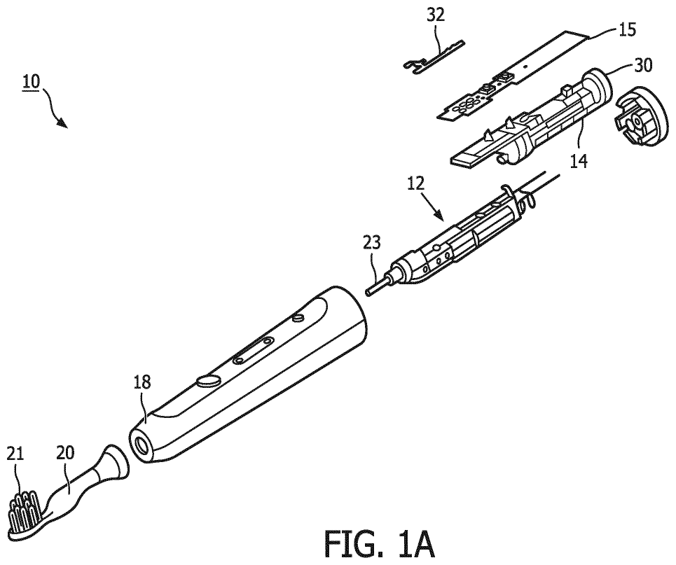

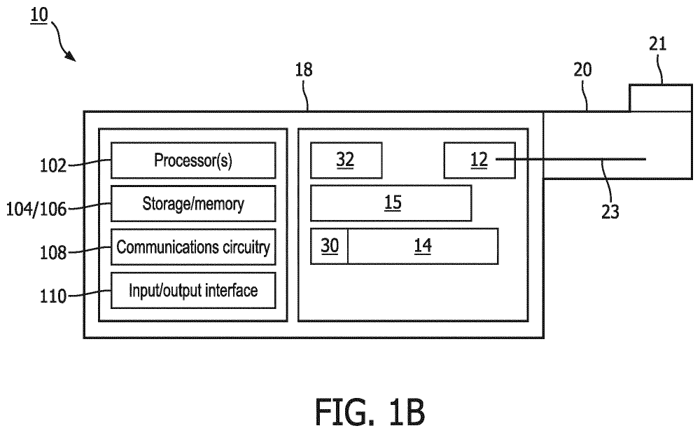

FIG. 1A is an exploded view of a personal hygiene device 10 in the form of a power toothbrush that includes a scrubbing detection method with a gravity compensation function. Persons of ordinary skill in the art will recognize that in other embodiments a personal hygiene device may refer to any product able to attend to an individual's personal hygiene, including, but not limited to, electric toothbrushes, non-electric toothbrushes, floss devices, water jets, tongue cleaners, or any other personal hygiene device, or any combination thereof. Furthermore, a personal hygiene device can be an electric shaver, hair trimmer, personal groomer, etc., and the illustrations are not limited to just personal hygiene scenarios.

Personal hygiene device 10 includes a housing 18 containing a drive train assembly 12 resonantly driven by a power system 14 which includes a battery and an electronics carrier, such as a printed circuit board. Personal hygiene device 10 further includes a printed circuit board with a microprocessor control 15 for creating a drive signal for power system 14. Removably secured to a drive stem 23 from the drive train assembly 12 is an attachment assembly 20, at the distal end of which is a brush member 21. At a rear end of drive train assembly 12 is a magnet 30. Mounted within personal hygiene device 10 are sensors 32 which can measure the acceleration and angular velocity of personally hygiene device 10 along three mutually perpendicular axes. Sensors 32 are capable of detecting the movement of attachment assembly 20. In some embodiments, sensors 32 may include an inertial measurement unit integrated in personal hygiene device 10. Sensors 32 are used to measure motions of personal hygiene device 10 and to generate motion data indicative of the motions of personal hygiene device 10.

As used herein, the IMU can include standalone accelerometers, gyroscopes, and/or magnetometers, or include parts or all of one or more inertial measurement units. In some embodiments, sensors 32 may include one or more accelerometers capable of determining how quickly (e.g., a velocity and/or acceleration) personal hygiene device 10 is moving and two or more gyros to measure changes in the rotation motion of personal hygiene device 10 by determining a change in an orientation. In some embodiments, an IMU may include three accelerometers and three gyroscopes (gyros) measuring orientation and movement in three coordinates. The IMU may be located on a single electronic chip wherein inertial sensors such as accelerometers can sense linear acceleration along one or several directions, and gyroscopes can measure angular motion about one or several axes. In some embodiments, the IMU may include a triaxial magnetometer.

FIG. 1B is a block diagram illustrating various components of personal hygiene device 10 in accordance with various embodiments. Personal hygiene device 10 may include a processor or processors 102, storage 104, memory 106, communications circuitry 108, and an input/output interface 110. These components may be located on microprocessor control 15 or may be located elsewhere within housing 18 of personal hygiene device 10. Processor 102 may include any processing circuitry, such as one or more processors capable of controlling the operations and functionality of personal hygiene device 10. In an embodiment, processor 102 may facilitate communications between various components within device 10, for example between sensors 32 and communications circuitry 108.

Memory 106, in the illustrated embodiment, may include one or more storage mediums. Various types of storage mediums include, but are not limited to, hard-drives, solid state drives, flash memory, permanent memory (e.g., ROM), or any other storage type, or any combination thereof. Any form of data or content may be stored within memory 106. Memory 106 may also include cache memory, semi-permanent memory (e.g., RAM), or any other memory type, or any combination thereof. Memory 106 may be used in place of and/or in addition to external storage for storing data on personal hygiene device 10.

Communications circuitry 108, in the illustrated embodiment, includes any circuitry capable of connecting to a communications network and/or transmitting communications (voice and/or data) to one or more additional user devices and/or servers.

Input/output interface 110 may include any suitable mechanism or component for receiving inputs from a user operating personal hygiene device 10 and/or generating outputs from a user operating personal hygiene device 10. In an embodiment, input/output interface 110 includes a display capable of displaying a user interface thereon.

Personal hygiene device 10 is operable to acquire data from sensors 32 or any other sensor resident therein, and analyze the data to determine a quality of a brushing motion of the user operating personal hygiene device 10. One or more algorithms present on personal hygiene device 10 may obtain data from sensors 32 and convert that data into numerical representations. The numerical representations may then be compared to a predefined value for brushing pressure, frequency, and/or quality.

In some embodiments, the analyzed data can be used to provide feedback to the user via input/output interface 110. For example, input/output interface 110 may include a display screen operable to display an analysis of the user's quality of brushing. In other embodiments, input/output interface 110 may provide an audio, visual, and/or haptic feedback to the user based on the analyzed data acquired by the sensors 32. In some embodiments, these kinds of feedback can be implemented in the brush handle, so feedback can be provided without the need to bring the user's smartphone, tablet or like device into the bathroom during toothbrushing.

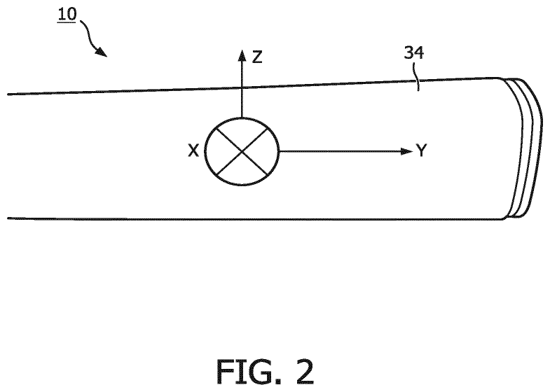

FIG. 2 illustrates the orientation of the IMU relative to the axes of personal hygiene device 10. A portion of handle 34 of personal hygiene device 10 is shown with three orthogonal axes indicated. The Y axis, also referred to herein as the first axis, extends generally along a longitudinal or lengthwise dimension of handle 34 of personal hygiene device 10. The X axis, also referred to herein as the second axis, is transverse, orthogonal or perpendicular to the Y axis. The Z axis, also referred to herein as the third axis, is transverse, orthogonal or perpendicular to the X and Y axes.

In some embodiments, sensors 32 can measure linear accelerations and rotational velocities, for example with a three-axis accelerometer and a three-axis gyroscope. The Y axis or first axis accelerometer can be used to detect scrubbing. The Y axis accelerometer may produce false scrubbing signals if, for example, the user slightly rocks the PTB up and down a bit while brushing since the Y axis accelerometer tilts up and down from a zero-g position (or horizontal position) when this is occurring. The output of the Y axis accelerometer increases or decreases as the sine of the angle from horizontal. In another example, if the user bends over the sink while the PTB is in the user's mouth, the Y axis accelerometer will go from a zero g position to a 1 g position. That motion looks like a very large scrubbing signal because slow rotations around the X axis or Z axis have a peak amplitude equal to the gravitation field or 9.8 m/sec2. By comparison, using the largest amplitude and frequency combinations of the embodiment described above, the peak value of the Y axis acceleration is:
0.5 cm stroke at 4.80 Hz=2.3 m/sec2 peak.
5.0 cm stroke at 2.15 Hz=4.6 m/sec2 peak.

Given the amplitude of the “false” scrubbing acceleration due to slow rotations about the X or Z axis, these rotations would result in false scrubbing feedback to the user. An autocorrelation stage in the scrubbing detection algorithm enhances all periodic signals including harmonics and sub-harmonics contained in these false scrubbing acceleration waveforms due to rotation in a gravitational field. Since the user cannot move in a perfect sinusoidal motion, the resulting waveform will always contain harmonics and sub-harmonics.

Table 1 below shows the sub-harmonics related to motion in the Y axis at the frequencies listed for a power toothbrush along with the equivalent roll rates.

TABLE 1
Sub-harmonics of key frequencies and equivalent rotation rates

| | | | Equivalent | | Equivalent | |
|---|---|---|---|---|---|---|
| | | | roll rate | Frequency | roll rate | Frequency |
| | Stroke | Equivalent | 2nd sub- | of 2nd sub- | 3rd sub- | of 3rd sub- |
| Frequency | Amplitude | roll rate | harmonic | harmonic | harmonic | harmonic |
| (Hz) | (cm) | (deg/sec) | (deg/sec) | (Hz) | (deg/sec) | (Hz) |
| 0.85 | 5.00 | 306.00 | 153.00 | 0.43 | 102.000 | 0.283 |
| 1.52 | 5.00 | 547.20 | 273.60 | 0.76 | 182.400 | 0.507 |
| 2.15 | 5.00 | 774.00 | 387.00 | 1.08 | 258.000 | 0.717 |
| 3.50 | 0.50 | 1260.00 | 630.00 | 1.75 | 420.000 | 1.167 |
| 4.15 | 0.50 | 1494.00 | 747.00 | 2.08 | 498.000 | 1.383 |
| 4.80 | 0.50 | 1728.00 | 864.00 | 2.40 | 576.000 | 1.600 |

To eliminate false scrubbing detection due to user motion in a gravitational field, the output of the X axis and Z axis gyros can be examined for excessive rotation of the personal hygiene device. As used herein, excessive rotation of the device is determined by obtaining a rotational value from the received rotation motion data and comparing the rotational value to a set rotational threshold value.

For example, in an embodiment, if either gyro has a rotation over 102 deg/sec, then the scrubbing detection algorithm should be prevented from turning on the haptic feedback for scrubbing (on-handle or in the app). But since the X axis gyro and the Z axis gyro are 90 degrees out of phase with respect to rotation of the handle, the X axis and Z axis gyros should be added “in quadrature” for a single value threshold that causes scrubbing to be disabled. For example, in pseudo code:
If square root of (x-gyro2+z-gyro2)>102 deg/sec, then stop scrubbing feedback to user

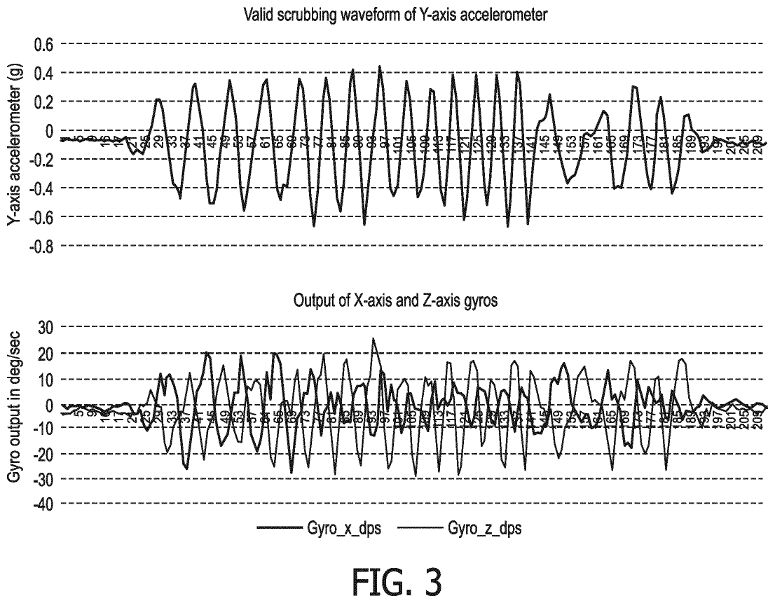

In some embodiments, when personal hygiene device 10 is powered on, motor noise can interfere with the inertial sensors. To prevent the scrubbing detection to be turned on due to motor noise, the threshold limit can be reduced. FIG. 3 shows waveforms of an example of the inertial sensor outputs for a typical user when scrubbing on the lingual teeth surface. The upper graph of FIG. 3 shows a waveform for a Y axis accelerator. The lower graph shows the output of X axis and Y axis gyros over time. As can be seen, the X axis and Z axis gyros do not exceed 50 deg/sec, while the Y axis accelerometer clearly indicates scrubbing. Therefore, in this example, reducing the threshold value to 50 deg/sec prevents motor noise from turning on scrubbing feedback, yet allows true scrubbing by the user to be detected. False scrubbing feedback due to rotation by the user is still eliminated using the lower threshold value of 50 deg/sec. The limits discussed above may be changed to accommodate different embodiments of the personal hygiene device.

In some embodiments, sensors 32 may include a triaxial magnetometer. The magnetometers can be used to sense rotation about the X and Z axes of the personal hygiene device. In this embodiment, the magnetometers are rotating in the Earth's fixed magnetic field of about 0.5 gauss. Since the X axis magnetometer and Z axis magnetometer are also in quadrature, the inclination and declination of the magnetic field do not affect the ability of the triaxial magnetometer to detect rotation. In some embodiments, triaxial magnetometers on an IMU can be used or a separate triaxial magnetometer may be used instead of using the triaxial gyros on an IMU chip.

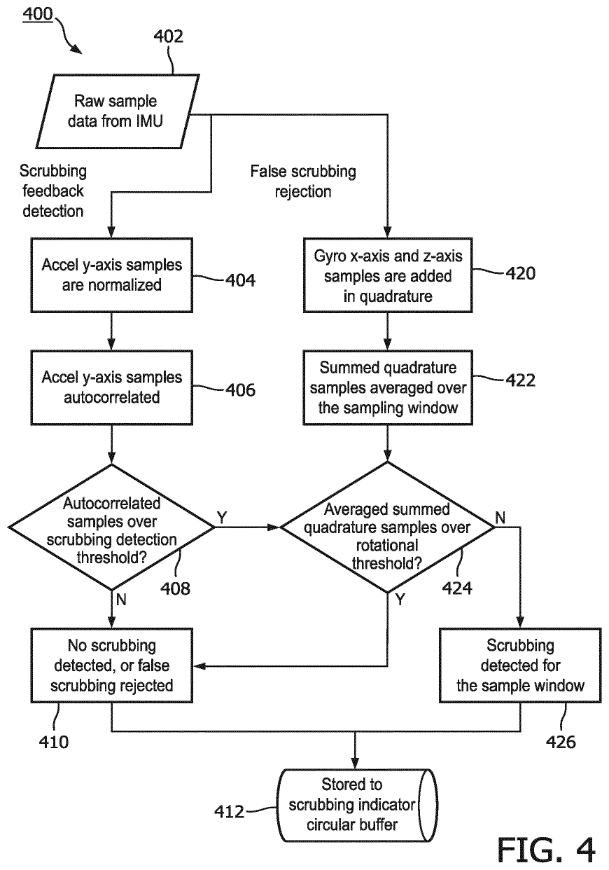

FIG. 4 illustrates an embodiment wherein elimination of false scrubbing feedback is implemented in a method 400 for providing scrubbing feedback to a user operating personal hygiene device 10. In the embodiment, X axis and Z axis gyroscope sensors are used to eliminate false scrubbing feedback. False scrubbing rejection steps are performed in parallel with scrubbing detection steps. A scrubbing action, i.e., a periodic motion of the power toothbrush as defined above, can be captured by the accelerometer, however due to sensor sensitivity, environmental noise or user behavior one cannot expect the accelerometer to capture ideal periodic signals.

In an example embodiment, method 400 begins at step 402 wherein data are acquired from sensors 32, such as an IMU, of personal hygiene device 10. In the scrubbing detection pathway, scrubbing motion data, which in this case are Y axis sample data received from an accelerator, are normalized at step 404. To emphasize periodic signals of the scrubbing action, the algorithmic chain for providing scrubbing feedback includes a step 406 wherein the input signal is correlated with itself. The autocorrelation step 406, wherein a cross correlation of a signal with itself is performed, is a mathematical tool for finding repeating patterns, such as the presence of a periodic signal obscured by noise with the advantage that the autocorrelation of a periodic signal is a periodic signal itself of the same period. The autocorrelation algorithm enhances periodic signals, but that enhancement also applies to harmonics and sub-harmonics of the sinusoidal scrubbing signature that is being detected. At step 408, the autocorrelated sample data are compared with a scrubbing detection threshold to determine whether scrubbing is present. If the autocorrelated sample data exceed the scrubbing detection threshold, the pathway continues to step 410 and it is determined that no scrubbing is detected. The sample data may be stored in a circular buffer at step 412.

Some prior methods to eliminate false scrubbing detection have required a large computational burden which is a disadvantage for use in a personal hygiene devices such as a power toothbrush. While there are many microcontrollers that could quickly perform the DCM matrix computations discussed above, the microcontrollers generally are more expensive thereby raising manufacturing costs of the device.

An advantage of the inventive subject matter is that the disclosed false scrubbing detection methods, using gyros or magnetometers to detect rotation, can be reliably implemented to provide a low-cost scrubbing detection solution. It is possible to distinguish the difference between accelerometer outputs due to true scrubbing from accelerometer outputs due to user rotation with an inertial (gyro) or non-inertial (magnetometer) rotation sensors. Instead of using a much more expensive microcontroller, embodiments of the inventive subject matter can use methods which are implemented on a less expensive microcontroller wherein only the X axis and Z axis gyros are monitored for excessive rotation.

In some embodiments, the obtained signals are already available to the firmware of the device so the inventive methods can be easily implemented in personal hygiene devices that contain an IMU. In other embodiments, a triaxial magnetometer can be used to eliminate false scrubbing feedback. Another advantage of the inventive subject matter is providing improved haptic, visual and/or audio feedback to the user. The present disclosure allows to do this with minimal interference with the existing internal assembly of the device and uses less computational resources.

The disclosed method for eliminating false scrubbing does not require an IMU with low-noise or precision performance. For example, a low-cost commercial grade MEMS IMUs with bias offsets on the order of 40 mg for the accelerometers and 10 degrees/sec for the gyros work can be used in the described implementation.

In embodiments of the inventive subject matter that are using gyro sensor outputs from an inertial sensor chip that is already in place inside the PTB, the firmware on the main microcontroller can be modified as described below.

As can be seen in the flowchart shown in FIG. 4, the process for rejecting false scrubbing in firmware begins at step 402 when gyro samples arrive from the IMU, and proceeds to step 420 where X axis and Z axis gyro samples are summed in quadrature. At step 422, the square root of the summed value is taken (as shown in Expression 1 below) before storing the values.

\sqrt{Xgyro²+Zgyro²} Expression 1: X axis and Z axis gyros added in quadrature

In step 422, the stored samples are averaged over a time-based sample window to produce a rotational value. In step 424, the obtained rotational value is compared to a set rotational threshold. If this rotational threshold value is exceeded, the corresponding scrubbing indication, calculated in parallel, will be rejected. In step 410, false scrubbing detection samples are rejected over the course of the sampling period to prevent false signaling of scrubbing to the user. If this rotational threshold value is not exceeded, the corresponding scrubbing indication proceeds to step 426 determining that scrubbing is detected for the sample window. The data may be stored in a circular buffer in step 412.

In another embodiment, instead of taking the square root of the summed values as described above, a simple summation method can be used. This summation method has a lower computational burden and is easier to implement than adding the X and Z axis gyros in quadrature shown in Expression 1. The summation method adds the X and Z axis gyros together and takes the absolute value of the result. The result is the same when the PTB rotation is about the X axis or the Z axis gyro. But for a rotation vector that is at a 45-degree orientation with respect to the gyros, the result is 1.414 times higher than the quadrature method since both axes sense 0.707 of the PTB rotation caused by the user. This means that instead of using a 50 deg/second threshold, a threshold value is set at 70.7 to avoid turning off a valid scrubbing motion detection by the user. In practice, the difference between the quadrature method and simple addition will not be noticed by the user.

In some embodiments, the performance of the firmware rests on the speed that a determination of scrubbing can be made as well as on the accuracy and resolution of the sample data. With that in mind, the microcontroller or microprocessor can be selected so as to balance these factors to achieve the best performance for the feature, while also allowing the processor selection to be cost-effective. Most modern microprocessor clock speeds will be able to meet the requirements for the collection and processing of the IMU data, but the way in which the data are handled internally can reduce cost of the processor as well as increase execution speed.

To achieve high resolution as well as accuracy of the data when different aspects of the detection algorithm are being calculated, two examples of implementations of the inventive subject matter are discussed below.

In one implementation, a processor that has support for floating-point operations is selected. With a dedicated internal module that allows for fast and efficient floating-point calculations, the scrubbing detection algorithm can be precise, accurate, and fast. Floating-point operations on traditional microprocessors without a dedicated floating-point unit are usually processor intensive and would not meet the necessary speed requirement. The inclusion of a floating-point unit is usually indicative of high-end devices and therefore the price point of the device may be higher.

In another implementation, a fixed-point notation is used to store and manipulate sample data. In a fixed-point notation, fractional numbers are represented by integer values and thus can be represented by standard data types. These standard data types fit into the base architecture of most microprocessors and therefore processor selection is not dependent on this aspect and a lower cost processor may be selected. The balancing act in this case is the resolution of the sampled data. Resolution of the data when using fixed-point notation is dependent on the bit width of the data type assigned to the sample data. A minimum of a 32-bit data type is necessary in this case to ensure that the resolution is high enough to not be susceptible to rounding errors, and 64-bit data types will yield more precise results. Since 32-bit microprocessors are quite common, cost will not be affected for this implementation. Microprocessors that support 64-bit operations are also common (if the base address size is 32-bits). 64-bit operations on a 32-bit processor are not as efficient, but still provide better performance than floating-point operations on a processor without a floating-point unit.

Overall, comparing cost to the available features of today's microprocessors, a fixed-point notation implementation will be the most cost effective and provide the most flexibility with processor selection. As technology evolves and floating-point units become more standard, then a floating-point implementation will be easier to develop and provide the same speed, accuracy, and slightly improved resolution.

Besides data handling, in an embodiment, the firmware implementation is also affected by the firmware architecture. Being able to process the sample data as they are received, while also servicing other tasks necessary to run the personal hygiene device, is greatly benefited by a real-time operating system architecture or RTOS. With this type of architecture, compared to a sequential execution or a bare-metal system, data can be handled as soon as they are present in the system. Within the RTOS architecture, the scrubbing feedback process would have its own associated task. This task can be executed whenever data is available to be processed and is able to interrupt other less important tasks in order to report scrubbing instantly to the user.

In one aspect, validation of the firmware implementation ensures that any changes to the code structure maintains the scrubbing functionality. In this way, a unit test may be developed in parallel to provide validation of the firmware. To validate, a representative data set, similar to what a real-world user would put a personal hygiene device through, may be fed into the firmware function and the output of the function can be compared to a validated resulting data set to confirm no changes occurred. This allows for continuous validation of any new firmware changes and ensures the scrubbing functions remain the same.

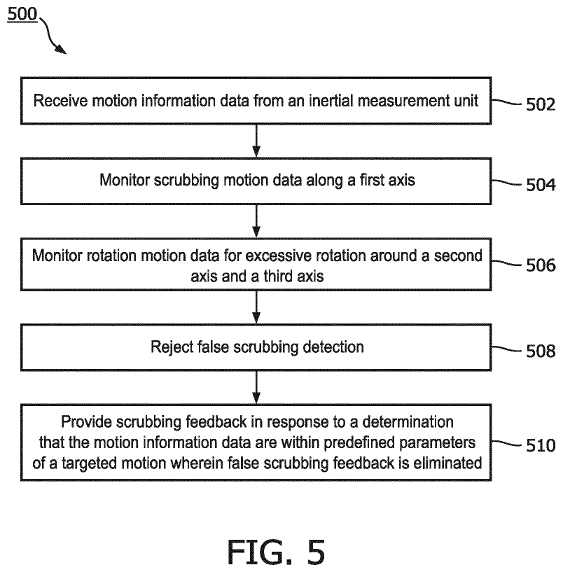

FIG. 5 shows a high-level flowchart of an example method 500 for detecting scrubbing motion during use of personal hygiene device 10. Method 500 begins at step 502 with receiving motion information data from an inertial measurement unit located within personal hygiene device 10. Non-limiting examples of motion information data may include scrubbing motion data and rotational motion data of the personal hygiene device as described above.

At step 504, scrubbing motion data of the personal hygiene device are monitored along a first axis. In one example, the scrubbing motion data received from a Y axis accelerator may be processed, as described above with reference to FIG. 4. At step 506, the method may include monitoring rotation motion data of the personal hygiene device for excessive rotation around a second axis and a third axis of the personal hygiene device. For example, X and Z axis rotational data from gyros can be retrieved, processed, and compared to rotational threshold values as described in the embodiments above.

At step 508, the scrubbing motion data are rejected when the retrieved rotational data exceed the rotational threshold value. At step 510, scrubbing feedback is provided to a user operating the personal hygiene device in response to a determination that the scrubbing motion information data are within predefined parameters of a targeted motion and false scrubbing feedback is eliminated from the provided scrubbing feedback. For example, extracted motion information of the personal hygiene device operated by the user is analyzed by comparing the extracted motion information to a predefined targeted motion for the personal hygiene device stored in memory on the user device. If it is determined that the received scrubbing motion information is within a predefined threshold range of the targeted motion of the personal hygiene device, a determination is made whether scrubbing is detected for a sample window and feedback may be provided to a user operating the personal hygiene device. For example, provided feedback may correspond to haptic feedback, audio feedback and/or visual feedback.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.” In addition, singular references do not exclude a plurality. Thus, references to “a”, “an”, “first”, “second” etc. do not preclude a plurality.

Reference signs in the claims are provided merely as a clarifying example shall not be construed as limiting the scope of the claims in any way.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

1. A method for detecting scrubbing motion during use of a personal hygiene device, the method comprising:
receiving motion information data of the personal hygiene device from an inertial measurement unit located within the personal hygiene device;
monitoring scrubbing motion data of the personal hygiene device along a first axis;
monitoring rotation motion data of the personal hygiene device for excessive rotation around a second axis and a third axis of the personal hygiene device;
rejecting a scrubbing motion detection when excessive rotation is detected; and
providing a user operating the personal hygiene device with scrubbing feedback in response to a determination that the motion information data are within predefined parameters of a targeted motion of the personal hygiene device, wherein false scrubbing feedback is eliminated from the scrubbing feedback.

2. The method of claim 1, wherein the inertial measurement unit includes at least two gyroscope sensors to determine rotation motion data of the personal hygiene device.

3. The method of claim 1, wherein the inertial measurement unit includes a triaxial magnetometer.

4. The method of claim 1, wherein excessive rotation of the personal hygiene device is determined by obtaining a rotational value from the received rotation motion data, comparing the rotational value to a set rotational threshold value, and rejecting the scrubbing motion detection when the rotational value exceeds the set rotational value.

5. The method of claim 4, wherein the rotational value is obtained by an averaged summed quadrature calculation.

6. The method of claim 4, wherein the rotational value is obtained by a summation calculation.

7. The method of claim 1, wherein the feedback includes haptic feedback, visual feedback, and/or audio scrubbing feedback.

8. A personal hygiene device for detecting scrubbing motion during use of the device, the personal hygiene device comprising:
an inertial measurement unit to measure motions of the personal hygiene device and to generate motion data indicative of the motions of the personal hygiene device;
at least one processor operable to, during an operating session:
obtain information from the inertial measurement unit corresponding to the scrubbing motion of the personal hygiene device;
obtain information from the inertial measurement unit corresponding to a rotation motion of the personal hygiene device;
calculate a rotational value from the received rotation motion information and compare the rotational value to a set rotational threshold value;
calculate a scrubbing motion indication in parallel with the rotational value;
reject the corresponding scrubbing motion indication when the rotational value exceeds the set rotational threshold value; and
provide the user operating the personal hygiene device with scrubbing feedback wherein false scrubbing detection feedback is eliminated.

9. The personal hygiene device of claim 8, wherein the inertial measurement unit includes at least one accelerometer to detect the scrubbing motion of the personal hygiene device.

10. The personal hygiene device of claim 8, wherein the inertial measurement unit includes at least two gyro sensors to detect rotation motion of the personal hygiene device.

11. The personal hygiene device of claim 8, wherein the inertial measurement unit includes a triaxial magnetometer.

12. The personal hygiene device of claim 8, further comprising an output interface operable to provide audio, visual, and/or haptic scrubbing feedback.

13. The personal hygiene device of claim 8, wherein the processor supports execution of floating-point operations.

14. The personal hygiene device of claim 8, wherein the processor supports execution of fixed-point operations.

15. A non-transitory computer-readable medium storing computer-executable instructions that, when executed by a processor, causes a personal hygiene device to perform a method comprising:
receiving motion information data of the personal hygiene device from an inertial measurement unit located within the personal hygiene device;
monitoring scrubbing motion data of the personal hygiene device along a first axis;
monitoring rotation motion data of the personal hygiene device for excessive rotation around a second axis and a third axis of the personal hygiene device;
rejecting a scrubbing motion detection when excessive rotation is detected; and
providing a user operating the personal hygiene device with scrubbing feedback in response to a determination that the motion information data are within predefined parameters of a targeted motion of the personal hygiene device, wherein false scrubbing feedback is eliminated from the scrubbing feedback.
